(19) United States
(12) Patent Application Publication
(10) Pub. No.: US 2003/0136180 A1
(43) Pub. Date: Jul. 24, 2003

(54) Method of directly measuring the permittivity of geotextile and biotextile fabrics

(76) Inventor: Moishe Garfinkle, Philadelpphia, PA (US)

Correspondence Address: Moishe Garfinkle, Post Office Box 15855, Philadelphia, PA, 19103, US

(21) Appl. No.: 09/788,698

(22) Filed: Feb. 20, 2001

Related U.S. Application Data
(60) Provisional application No. 60/185,857, filed on Feb. 29, 2000.

(51) Int. Cl. G01N 15/08

(52) U.S. Cl. 73/38

(57) ABSTRACT

A method of measuring the permittivity of porous media by passing a fluid from a chamber with a decreasing volume to a chamber with an increasing volume through the media. The volume of the cylindrical chambers is controlled by pistons with coaxial piston rods connected externally and driven by an electric motor, determining the fluid flow through the porous media while transducers in each chamber measure the pressure difference across the porous media. In addition means are provided to observe the fluid flow though the porous media using a video camera.

### BACKGROUND OF THE INVENTION

The rate at which fluids pass through a porous medium such as a textile fabric is of crucial importance in many technical fields, for example geotextiles for soil stability in civil engineering and biotextiles for prostheses in biomedical engineering. While it might appear that the measurements of fluid flow rates should be relatively simple, this has not been the case. According to the conventional method of flow rate determination an ostensibly uniform pressurized fluid from a reservoir flows through a section of the fabric to atmospheric pressure in free flow. Because of the difficulty involved in maintaining constant pressure during each test and different uniform pressures during a series of tests, particularly with exit stream contraction, the flow rate can be quite erratic.

In practice the flow rate of a fluid of viscosity μ is proportional to the pressure difference imposed across a fabric. The relationship between flow rate and pressure difference can be expressed as a classical phenomenological equation between flux term Φ and a force term ΔP.

Φ=π_{S}ΔP/μ (1)

The flux term Φ is the fluid velocity (volume flow rate per unit area) through the fabric and the force term ΔP is the pressure difference across the fabric. The linear phenomenological coefficient for streamline flow π_{S} is denoted the permittivity. Hence to experimentally determine the value of the permittivity requires that the ratio of the fluid velocity to the pressure difference be measured.

π_{S}=(Φ/ΔP)μ (2a)

However if the fluid flow is turbulent rather than streamline a turbulent permittivity π_{T} must be considered that is not linearly proportional to the fluid velocity.

π_{T}=(Φ²/ΔP)μ (2b)

In practice the flow conditions at which streamline flow becomes turbulent is difficult to delineate.

### SUMMARY OF THE INVENTION

In response to these problems associated with measuring fabric permittivity directly a method of permittivity testing has been developed to directly determine either π_{S} or π_{T}. The ratio (Φ/ΔP) calculated from Φ and ΔP pairs determined for a series of different flow rates would delineate the point at which fluid flow changes from streamline to turbulent flow, if such a point is present.

### OBJECTIVE OF THE INVENTION

According to the disclosed invention this method of permittivity testing consists of passing an essentially constant volume of a fluid from one chamber with a decreasing volume to another chamber with an increasing volume through a connecting orifice, the sum of the volumes of the chambers being constant. The fabric to be tested is interposed across the orifice, with the sum of the volumes of the two chambers essentially constant, permitting both the pressure difference across the fabric and the fluid flow velocity to be measured directly and simultaneously.

This is accomplished by two coaxial pistons equipped with O-rings moving in synchronous motion within a cylinder, as shown in FIG. 1. Between the pistons the fabric to be tested is stretched across an orifice defined by the specimen holder. The fluid fills the space between the pistons. An actuation system moves the pistons. As the pistons move the fluid is forced through the fabric. The fluid velocity Φ can then be measured directly from the cylinder diameter and the pressure difference across the fabric ΔP can be measured directly from the pressure transducers.

After several cycles the the piston travel speed can be increased incrementally until until sufficient data is gathered to construct a chart of fluid flow versus pressure differential. A straight line portion is indicative of laminar flow.

### DRAWINGS

FIG. 1. Laboratory model of permittivity measuring device

FIG. 2. Detail of permittivity measuring device

FIG. 3. Detail of actuation system

FIG. 4. Quantities Measured

FIG. 5. Detail of orifice plate

### PREFERRED EMBODIMENT

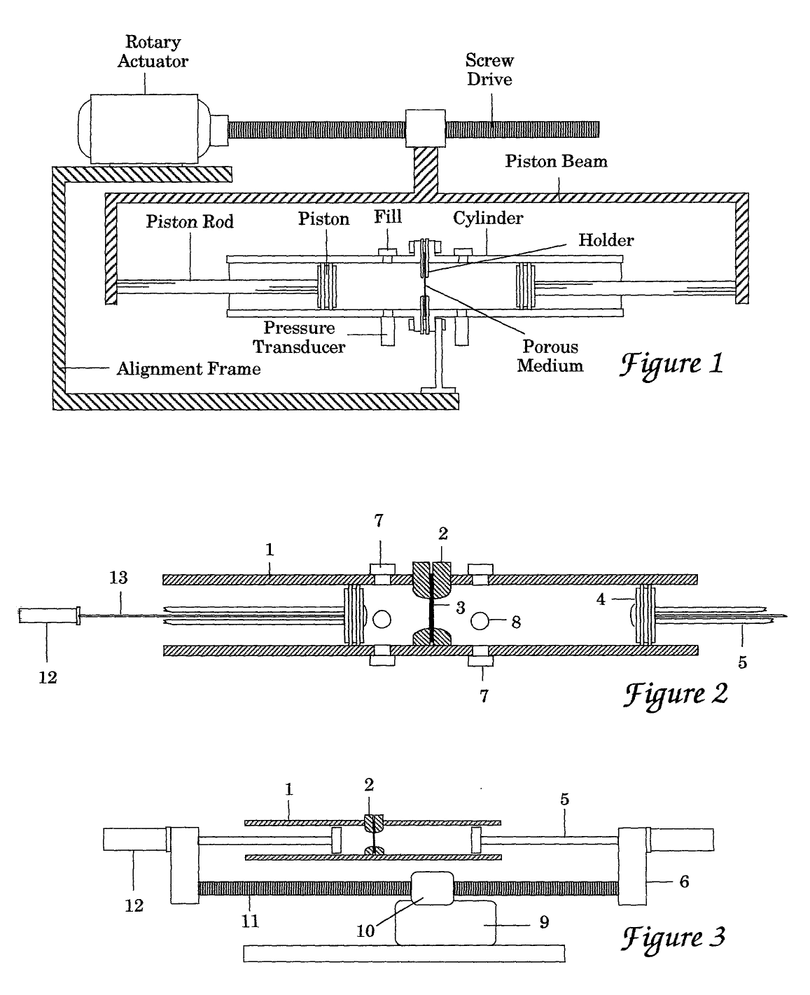

FIGS. 2 and 43 illustrate an example of an apparatus conducive to the direct measurements of Φ and ΔP according to the disclosed method. A stationary hollow cylinder 1 with orifice plates 2 positioned essentially at the center of the 1. The porous medium 3 to be tested is secured between the orifice plates 2. The pistons 4, each secured to a coaxial piston rod 5 and slideably positioned within cylinder 1, have synchronized axial motion inasmuch as the two piston rods 5 are secured to a common piston frame 6. The frames 6 are detachable from the rods 5 and screw 11. The two pistons 4 thereby enclose the two volumes separated by the porous medium 3 to be tested, with the sum of the two volumes essentially constant. The cylinders 1 are equipped with fill and drain openings 7 and pressure transducers 8.

The actuator motor 9 drives screw nut 10 which it turn moves the screw 11 laterally. The entire operation can be automated.

The piston rods 5 can be hollow, extending through said piston 4, with a optical cable 12 placed within and lens 13 secured to the face of the piston 4. In this manner observation can be made on the pore distortions of the porous medium 3. The video camera 12 images the porous medium 3.

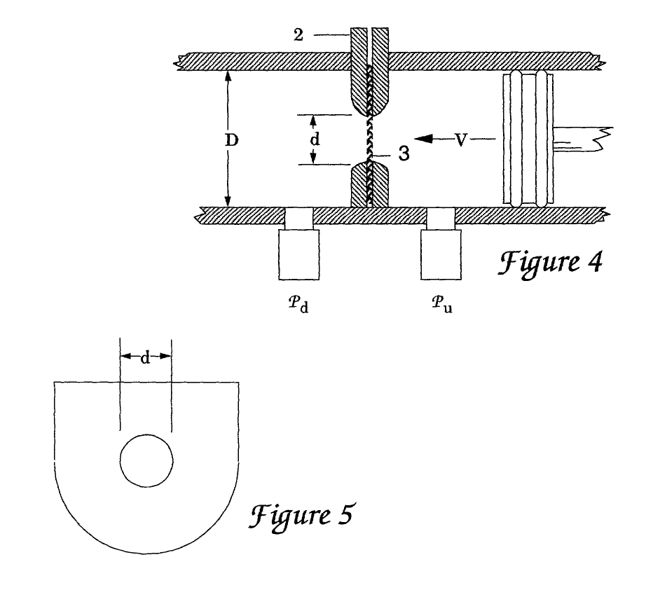

FIG. 4 illustrates the permittivity terms that can be measured directly using the disclosed method and from which the phenomenological coefficient can be calculated from equations (2a) or (2b). The diameter D is that of the cylinder 1 and d is that of the circular orifice of plate 2.

The orifice plates 2, shown in detail in FIG. 5, defines the wetted area of the porous medium 3, with plates 2 with different orifice areas used with different porous media 3. Essentially the greater the permittivity of the porous medium 3 tested the smaller the required orifices of the plates 2.

The velocity Φ of a fluid through the porous medium 3 is simply

Φ=V(D/d)² (3)

where V is the linear piston 4 travel speed.

The required pressure difference ΔP is measured from the pressure readings at the transducers 8 and is simply

ΔP=Pᵤ−P_{d} (4)

where Pᵤ and P_{d} are the upstream and downstream pressure readings, respectively.

Accordingly, from a series of tests using the disclosed permittivity measuring method for a fluid of known viscosity μ, either π_{S} or π_{T} can be directly calculated from the measured values of Φ and ΔP. In this manner reproducible permittivity determinations can be made for porous media, primarily those used for geotextile and biotextile purposes.

While there have been described what is at present considered to be the preferred embodiment of a method of directly measuring the permittivity of porous media, it will be obvious to those skilled in the art that various changes and modifications may be made therein without departing from the invention. It is aimed therefore in the appended claims to cover all such changes and modifications as fall within the true spirit and scope of the invention so that others may, by applying current and future knowledge, adopt the same for use under various conditions of service.

I claim:

1 A method of directly measuring the permittivity of a porous medium by passing a fluid through said medium, said medium confined between two chambers, wherein the volume of on( chamber is decreased and the other chamber increased by a like amount, whereupon said fluid is forced through said medium, the rate of flow dependent on the rate said volume of said chambers is altered,
the pressure of said fluid in each said chamber measured to determine the pressure across said medium, said permittivity measured by the ratio of said fluid flow to the pressure difference across said medium.

2 A method according to claim 1 wherein said porous medium is placed between orifice plates which define the wetted area of the porous medium, said orifice plates positioned within a cylinder,
a pair of pistons externally connected so as to move in synchronous motion, said pistons positioned within said cylinder on either side of said porous medium positioned between orifice plates, the volume between said pistons filled with a fluid,
whereupon said fluid is forced through said porous medium by motion of said pistons.

3 A method according to claim 2 wherein said pistons are connected to said coaxial piston rods externally connected to piston frames and said piston frames connected to a screw shaft,
upon rotation of a screw nut rotatably connected to said screw shaft, said screw shaft moves axially, moving said coaxial piston rods,
whereupon said pistons move simultaneously in synchronous motion.

4 A method according to claim 2 wherein said piston frames are detachable, permitting said pistons to removed from said cylinder.

5 A method according to claim 3 wherein said screw nut rotatably connected to said screw shaft, is rotated by an electric motor.

6 A method according to claim 3 wherein said coaxial piston rods are hollow, extending through said pistons, wherein an optical cable placed within said piston rod and a lens secured to the face of said piston permits imaging of said porous medium, said image transmitted by video cameras.
